(19) United States
(12) Patent Application Publication
(10) Pub. No.: US 2022/0348446 A1
(43) Pub. Date: Nov. 3, 2022

(54) WIRE AND CONDUIT REEL HANDLER

(71) Applicants: JOHN KETCHESIDE, Parma, ID (US); WILLIAM W. WHITE, Wilder, ID (US)

(72) Inventors: JOHN KETCHESIDE, Parma, ID (US); WILLIAM W. WHITE, Wilder, ID (US)

(21) Appl. No.: 17/728,576

(22) Filed: Apr. 25, 2022

Related U.S. Application Data
(60) Provisional application No. 63/180,760, filed on Apr. 28, 2021.

(51) Int. Cl. B66F 9/18

(52) U.S. Cl. CPC B66F 9/18

(57) ABSTRACT

Disclosed embodiments include a cable reel adaptor formed as an elongated bar having a first end and a second end with at least one tine shoe attached to the elongated bar that engages a forklift tine. The adaptor includes a first angled track at the first end of the elongated bar and a second angled track at the second end of the elongated bar.

### CROSS-REFERENCE TO RELATED APPLICATIONS

This application, under 35 U.S.C. § 119, claims the benefit of U.S. Provisional Patent Application Ser. No. 63/180,760 filed on Apr. 28, 2021, and entitled “Wire And Conduit Reel Handler,” the contents of which are hereby incorporated by reference herein.

### FIELD OF THE DISCLOSURE

This disclosure relates generally to material handling equipment. More particularly, this disclosure relates to a forklift adaptor that enables safe and efficient handling of spool mounted material such as wire, conduit, or the like.

### BACKGROUND

Many individuals working in warehouses, the construction industry, underground utilities (e.g., power lines, internet cables, etc.), and the like must transport cable, conduit, or other reels, which are typically stored on generally circular spools. Such spools can be particularly difficult to properly transport, as the rounded shape can prevent stable lifting and transport of the cable reel. Should the cable reel fall from the lifting mechanism, such as a forklift, the cable reel can cause damage to the warehouse, cable reel, or even possibly injure nearby workers. Damage to the cable reel and surrounding area can be costly to replace or repair. Accordingly, systems and method for can safely and efficiently transporting a cable reel using a typical forklift are desired. Other inefficiencies, drawbacks, and issues with existing cable reel transport systems and methods also exist.

### SUMMARY

Accordingly, disclosed embodiments address the above-mentioned, and other, inefficiencies, drawbacks, and issues with existing cable reel transport systems and methods.

Disclosed embodiments include a cable reel adaptor including an elongated bar having a first end and a second end, at least one tine shoe attached to the elongated bar and configured to engage a forklift tine, a first angled track at the first end of the elongated bar, and a second angled track at the second end of the elongated bar.

Further disclosed embodiments include at least one edge sideguard on the first angled track and at least one edge sideguard on the second angled track. In some embodiments, the at least one tine shoe is selectively positionable at different locations along the elongated bar.

Further disclosed embodiments include at least one securing line attached to the elongated bar at one end and configured to attach to a forklift at a second end.

In some embodiments, the first and second angled tracks are selectively positionable at different locations along the elongated bar. In some embodiments, the first and second angled tracks are selectively positionable at different angles with respect to the elongated bar.

In some embodiments, the at least one edge sideguard on the first or second angled track is selectively positionable at different locations along the first or second angled track.

Further disclosed embodiments include at least one lift hook attached to the elongated bar. Other embodiments also exist.

### BRIEF DESCRIPTION OF THE DRAWINGS

FIG. 1 is an isometric view of a cable reel handling adaptor mounted on forklift tines in accordance with disclosed embodiments.

FIG. 2 is a front view of a cable reel handling adaptor mounted on forklift tines in accordance with disclosed embodiments.

FIG. 3 is an isometric view of a cable reel handling adaptor engaging a cable reel in accordance with disclosed embodiments.

FIG. 4 is a side view of a cable reel handling adaptor lifting a cable reel in accordance with disclosed embodiments.

FIG. 5 is a side view of a cable reel handling adaptor placing a cable reel on a spool support in accordance with disclosed embodiments.

FIG. 6 is an isometric view of a cable reel handling adaptor in accordance with disclosed embodiments.

FIG. 7 is a front view of a cable reel handling adaptor in accordance with disclosed embodiments.

FIG. 8 is an isometric view of a cable reel handling adaptor with lift hooks in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

Exemplary embodiments are disclosed herein with reference to mounting an adaptor on a forklift. However, persons of ordinary skill in the art having the benefit of this disclosure will recognize that any suitable lifting equipment, hydraulic or otherwise, may be implemented. For example, backhoes, skid steers, bull dozers, plows, tractors, and the like, may be equipped with suitable forks or tines capable of being used with disclosed embodiments.

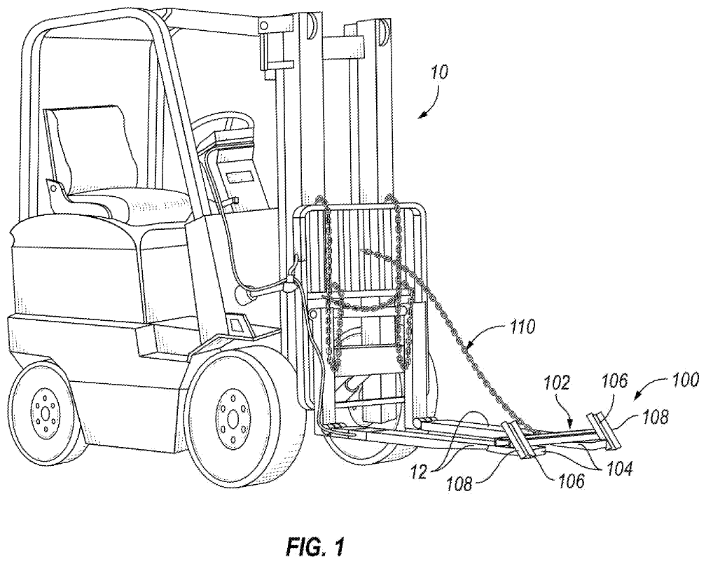

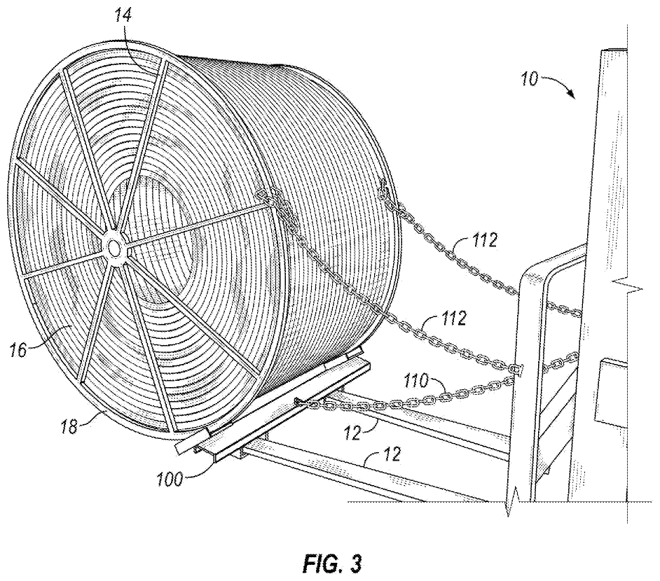

FIG. 1 is an isometric view of a cable reel handling adaptor 100 mounted on forklift 10 tines 12 in accordance with disclosed embodiments. As shown, embodiments of the cable reel handling adaptor 100 include an elongated bar 102 extending between a pair of tine shoes 104. The tine shoes 104 removably receive the ends of a pair of forklift tines 12 such that the elongated bar 120 extends transversely across the pair of forklift tines 12. A pair of angled tracks 106, each having outer edge sideguards 108, are affixed to the opposing ends of the elongated bar 102, such that the tine shoes 14 are positioned between the angled tracks 106. In the illustrated embodiment, the angled tracks 106 include a pair of sideguards 108 on opposing edges of each angled track 106 to retain a cable reel 16 thereon. The angled tracks 106 are configured to form a ramp to receive opposing circular spool edge 18 of the cable reel 16 as it is moved onto the forklift 10 for transport. In this way, the elongated bar 102 evenly distributes the weight of the cable reel 16 across the pair of forklift tines 12. Additionally, in some embodiments, a securing line 110, such as a steel cable, chain, or the like, connects between a rear side of the elongated bar 102 and a part of the forklift 10, or other portion of the tine lifting mechanism, in order to secure the adaptor 100 to the forklift tines 12. Additional securing lines 112 (see, e.g., FIGS. 3-5) can be utilized to secure the cable reel 16 to the adaptor 100 and to the forklift 10, or other portion of the tine lifting mechanism, at the front of the forklift 10.

In some embodiments (e.g., FIG. 7), the adaptor 100 is adjustable (e.g., tine shoes 104 may be selectively positionable) to fit different types, widths, spacing, and sizes of forklift tines 12. Likewise, angled tracks 106 may be adjustable in width, spacing, tilt angle, and size, to handle different types and sizes of cable reels 16 or similar objects.

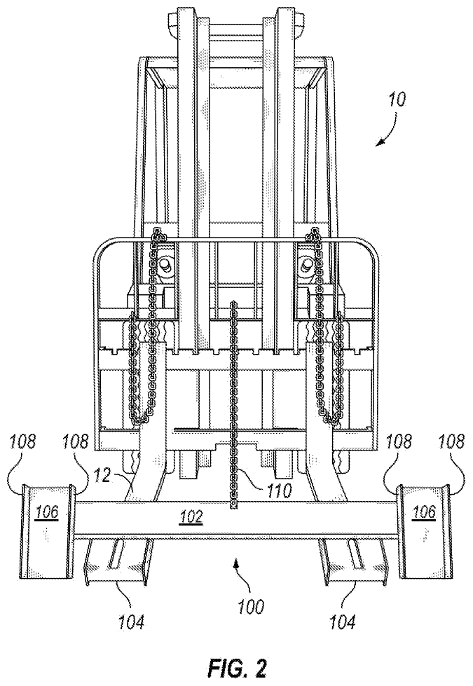

FIG. 2 is a front view of a cable reel handling adaptor 100 mounted on forklift tines 12 in accordance with disclosed embodiments. As shown, tine shoes 104 are sized to securely fit over forklift tines 12. Securing line 110 assists in keeping adaptor 100 securely engaged against the front of forklift tines 12.

FIG. 3 is an isometric view of a cable reel handling adaptor 100 engaging a cable reel 16 in accordance with disclosed embodiments. As shown in FIG. 3, adaptor 100 may be used to lift a cable reel 16 by engaging the spool frame 14 at the spool edges 18 with the angled tracks 106 in order to lift cable reel 16 from the ground. As also shown, additional securing lines 112 may also be attached to the spool frame 14 for additional load security.

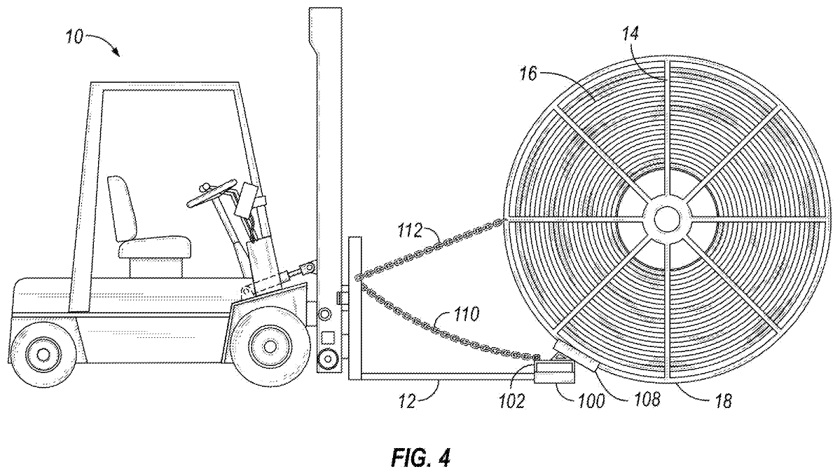

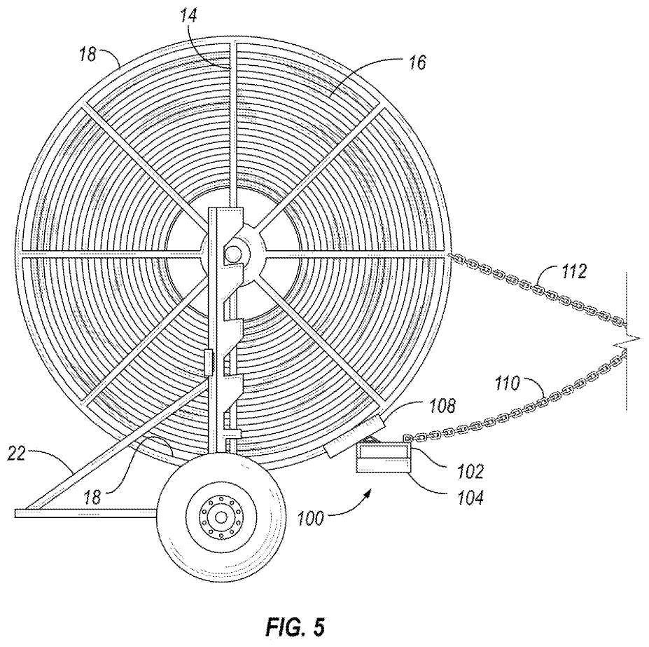

FIG. 4 is a side view of a cable reel handling adaptor 100 lifting a cable reel 16 in accordance with disclosed embodiments. As shown, when the forklift tines 12 are lifted, angled tracks 106 engage the spool frame 14 at the spool edges 18 to securely lift the cable reel 16. Edge sideguards 108 assist in keeping the spool edges 18 from moving laterally and additional securing lines 112 keep the spool frame 14 from rotating. As shown in FIG. 5, disclosed embodiments enable a single operator to safely and efficiently position a cable reel 16 on a spool support 22, or the like.

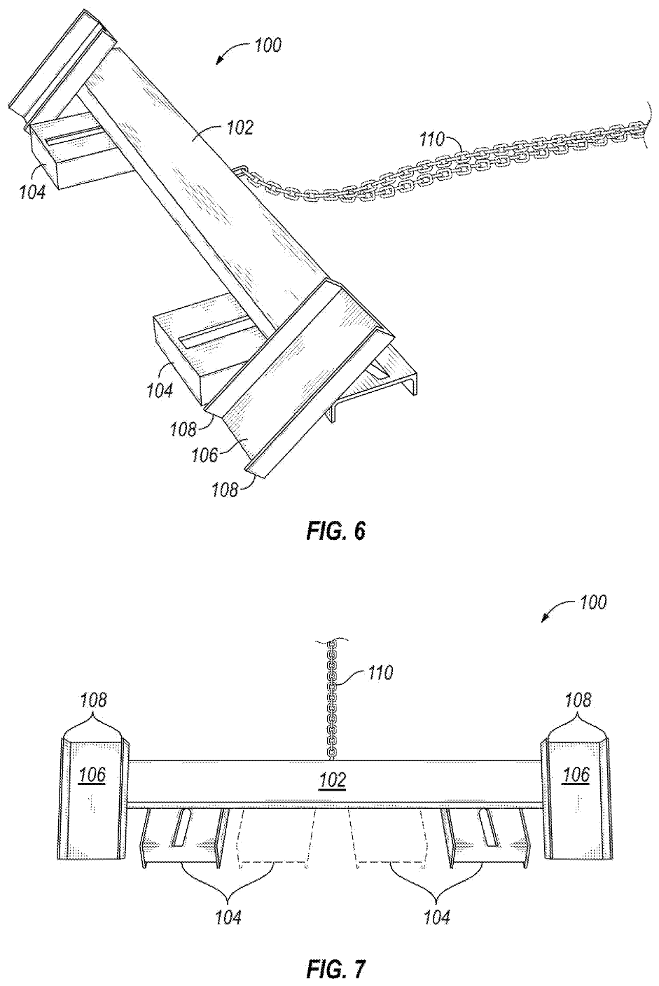

FIG. 6 is an isometric view of a cable reel 16 handling adaptor 100 in accordance with disclosed embodiments. As shown, adaptor 100 may be welded steel or the like. As indicated in FIG. 7, embodiments of adaptor 100 may include moveable tine shoes 104 to accommodate different forklift tine 12 spacings. Likewise, as would be apparent to those of ordinary skill in the art having the benefit of this disclosure, angled tracks 106, edge sideguards 108, and elongated bar 102 may also be adjustable in some embodiments.

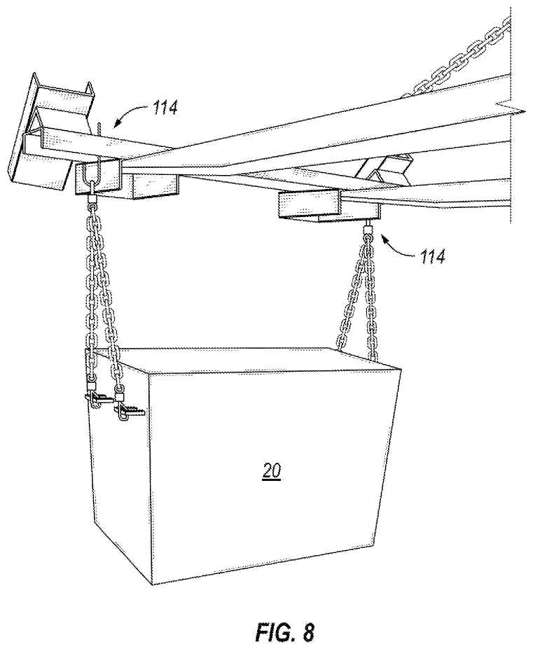

FIG. 8 is an isometric view of a cable reel 16 handling adaptor 100 with lift hooks 114 in accordance with disclosed embodiments. As shown, embodiments of adaptor 100 may also include lift hooks 114 to enable forklift 10 to lift other objects 20 without the need to remove the adaptor 100 from the forklift tines 12.

Although various embodiments have been shown and described, the present disclosure is not so limited and will be understood to include all such modifications and variations would be apparent to one skilled in the art.

What is claimed is:

1. A cable reel adaptor comprising:
an elongated bar having a first end and a second end;
at least one tine shoe attached to the elongated bar and configured to engage a forklift tine;
a first angled track at the first end of the elongated bar; and
a second angled track at the second end of the elongated bar.

2. The cable reel adaptor of claim 1 further comprising:
at least one edge sideguard on the first angled track.

3. The cable reel adaptor of claim 1 further comprising:
at least one edge sideguard on the second angled track.

4. The cable reel adaptor of claim 1 wherein the at least one tine shoe is selectively positionable at different locations along the elongated bar.

5. The cable reel adaptor of claim 1 further comprising:
at least one securing line attached to the elongated bar at one end and configured to attach to a forklift at a second end.

6. The cable reel adaptor of claim 1 wherein the first angled track is selectively positionable at different locations along the elongated bar.

7. The cable reel adaptor of claim 1 wherein the first angled track is selectively positionable at different angles with respect to the elongated bar.

8. The cable reel adaptor of claim 1 wherein the second angled track is selectively positionable at different locations along the elongated bar.

9. The cable reel adaptor of claim 1 wherein the second angled track is selectively positionable at different angles with respect to the elongated bar.

10. The cable reel adaptor of claim 2 wherein the at least one edge sideguard on the first angled track is selectively positionable at different locations along the first angled track.

11. The cable reel adaptor of claim 3 wherein the at least one edge sideguard on the second angled track is selectively positionable at different locations along the second angled track.

12. The cable reel adaptor of claim 1 further comprising:
at least one lift hook attached to the elongated bar.
